(19) United States
(12) Patent Application Publication
(10) Pub. No.: US 2004/0244443 A1
(43) Pub. Date: Dec. 9, 2004

(54) Rotary security system

(76) Inventor: John Calhoun Martin, Hunt, TX (US)

Correspondence Address: John C. Martin, P.O. Box 434, Hunt, TX, 78024, US

(21) Appl. No.: 10/456,924

(22) Filed: Jun. 9, 2003

(51) Int. Cl. E05B 65/06

(52) U.S. Cl. 70/129

(57) ABSTRACT

A sliding bar contains a slot on one end so that bar movement passes shackle rods of an opened padlock. The bar is positioned on a rigid arm extending from a column that also supports a plate which can be rotated. Shackles of multiple padlocks are held uniformly on the plate. Shape of bar is such that its effective movement cannot occur when padlocks are closed. When a specific padlock is opened with its required key and rotated so its lengthened shackle rods are in front of the bar, movement of bar can occur. The slot allows sufficient bar movement to actuate a powered gate-opener, release a gate latch, or initiate other action. Imprinted numbers identify each padlock, and a pointer aids shackle-arm location in front of slotted bar. Advantages include security, access from car-windows, identifying unauthorized key-holders, and elimination of multiple key replacements when only one lock is used. Equipment size can vary so as to service between 7 and more than 150 authorized individuals.

### U.S. PATENTS CITED AS REFERENCES

| | | | |
|---|---|---|---|
| 2,707,125 | April 1955 | Ritter | 292/341.15 |
| 2,856,220 | March 1957 | Easley | 292/148 |
| 2,963,895 | December 1960 | Thomas | 70/14 |
| 3,656,789 | April 1972 | Ray | 292/304 |
| 3,731,505 | May 1973 | Rosenberg | 70/63 |
| 3,889,497 | June 1974 | Tuttle | 70/14 |
| 3,926,018 | June 1975 | Joersz | 70/19 |
| 3,988,031 | October 1976 | Meyer | 292/153 |
| 4,085,599 | April 1978 | Fischer | 70/14 |
| 4,240,278 | December 1980 | Linder | 70/101 |
| 4,697,443 | October 1987 | Hillin | 70/121 |
| 4,997,219 | March 1991 | Carter | 292/153 |

### BACKGROUND INFORMATION

Electrically powered gate-openers are currently installed or being considered at the entrance to enclosed areas such as estates, ranches, private clubs, private roadways, sport facilities, home sites, retirement areas, and other locations entered by authorized personnel or their guests. The typical way to actuate a powered gate-opener is to reach from a car window and use a key to operate a switch. Wireless monitors may also be used for the same purpose. After entry, the gate closes automatically. To exit later, a push-button or wireless monitor may be used, or the car itself may actuate a buried sensor that serves the purpose of an opening switch. The latter concept is becoming common.

In many cases where gate-openers are installed, there is a need to provide one or more keys to the opening switch for each of those who are authorized to enter. Inevitably this causes problems because such keys can be duplicated easily and given to friends, business associates, repair personnel, and others not authorized to enter regularly. The use of a combination lock does not mitigate such problems. When those who make their keys available to others are identified, correcting the problem involves difficulties when all authorized entrants use the same key. Since those at fault are likely to be either friends, neighbors, customers, or others who should not be offended, forceful action may be inappropriate. If such action must be taken, changing the keyed lock requires transmitting new keys to all others.

The rotary security system, herein described, can minimize such problems. Each authorized entrant is provided with one or more keys to a separate padlock. If one of those so authorized is found to be in repeated violation of stated rules, a single padlock can then be interchanged with one not yet in use, and a new key given to the miscreant. No change is required in keys held by other authorized personnel. To avoid harsh criticism of friends or customers who are at fault, such a change in locks can be made along with a simple statement such as “Your new key is sent because someone has gained access to your lock.”

The rotary security system can be erected for use from a car window, just as a key-operated switch is now utilized. Wiring is not visible. One feature involves a pointer that normally indicates the identity of an authorized individual who previously either entered personally or who gave a key to someone else.

Numerous patents have been issued regarding the use of multiple padlocks, any one of which, when opened, serves to permit entry to an enclosed area. The previous list of references identifies some of these, most of which have the following disadvantages in relation to the rotary security system: not adaptable to car-window usage; limitation as to number of padlocks accommodated; not adaptable to electrical sensing; no clear identification of specific padlocks; padlocks must in most cases be removed; and no means of identifying a previous entrant. Most of these previously patented devices are apparently intended to serve as manually operated links to secure a gate. The rotary system will accomplish that also, at low cost, and without the disadvantages just noted.

Many situations exist in which only a limited number of individuals are authorized to make use of specific equipment such as a boat, truck, farm equipment, snowmobile, expensive office equipment, locker rooms, remote housing facilities, large storage rooms, etc. Passing out the same key to those authorized to use such equipment involves the same problem that occurs with giving or lending keys to others for entry to enclosed areas. Corrective problems are also the same as noted. Where equipment of this kind can be chained at a specific point, or where an electrical opener can be installed, use of the rotary security system serves to minimize such problems.

### SUMMARY

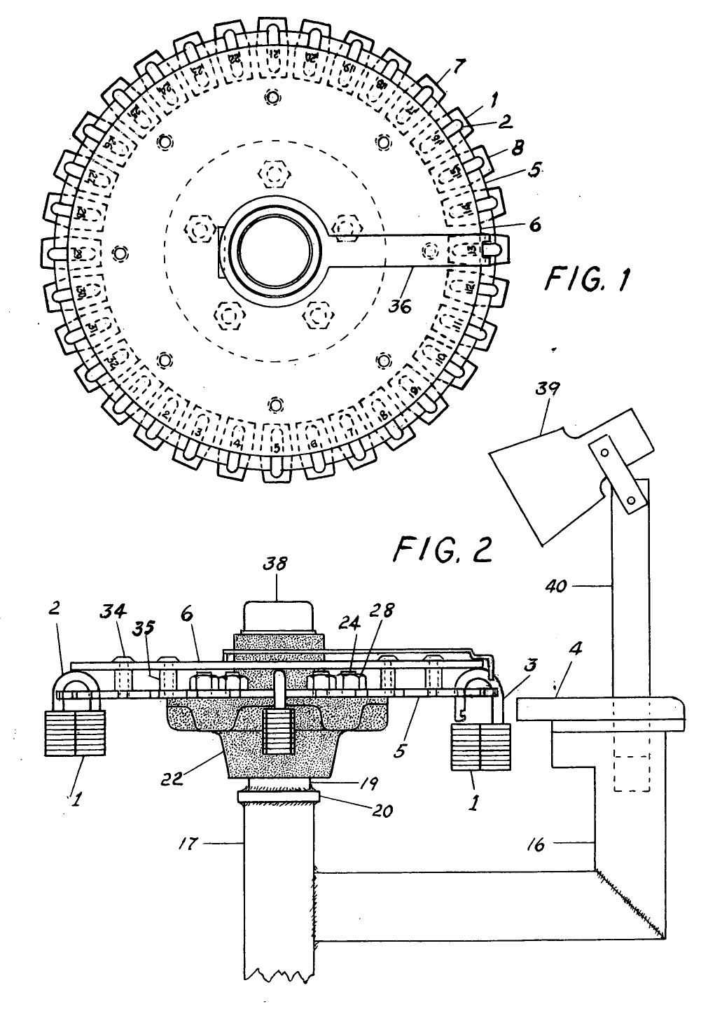

FIG. 1 is a top view of dual circular metal plates that can be rotated. Shackles of multiple padlocks are supported by a lower plate. An arbitrary number of thirty-two padlocks is shown in this drawing, identical in shape but keyed differently. A top plate surmounts all shackles. Numbers stamped on the top plate serve to identify each assigned padlock. A pointer can be turned by hand to aid in peripheral location of a specific padlock that has been opened, prior to action described below.

FIG. 2 shows how the lower plate is secured to a central hub for rotation. The swinging arm of each shackle extends through a hole in the lower plate. The other shackle arm fits within a half-circular hole at the edge of said plate. Both the complete hole and half-circular hole are on a radial line from the rotational center. Hole diameters are approximately 1/32-inch larger than shackle bars. Cap-screws secure the top plate to lower plate, with each screw passing through a metal sleeve that permits tightening screws so the top plate presses firmly against each shackle, thereby facilitating closure of an opened padlock by one hand. To avoid complexity of the drawing, only three of the multiple padlocks are pictured. Along an edge of the lower plate, the drawing indicates locations of others. All padlocks are evenly spaced, with minimal clearance between each. The padlock pictured on the right, at which the pointer has been located, is shown after being opened so as to increase length between shackle arms and base. Doing so permits movement of a slide that can actuate a powered gate-opener or initiate other action. A lamp provides for recognition of lock numbers at night.

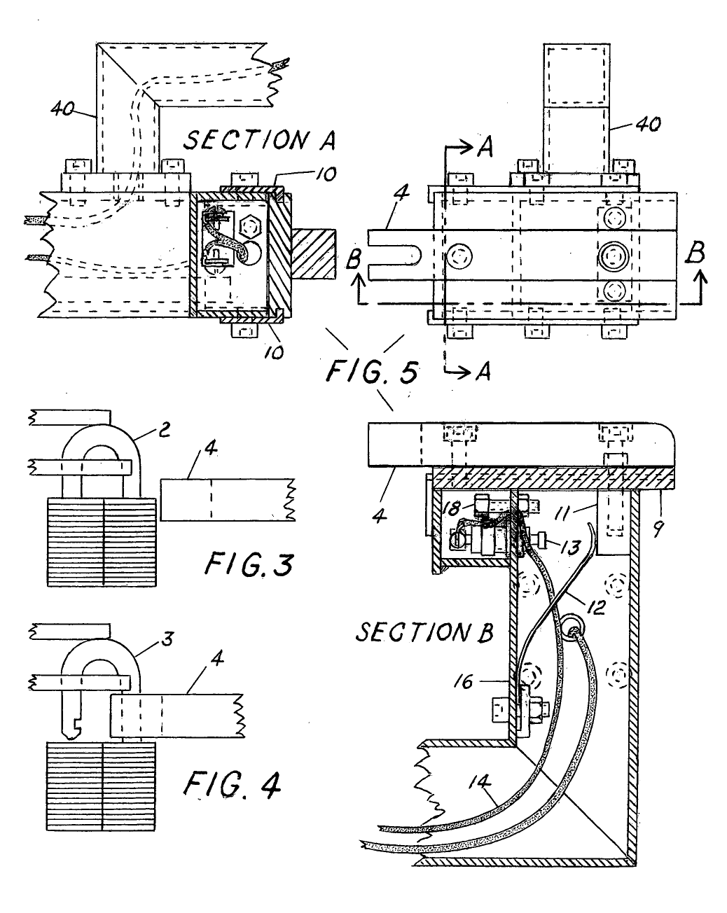

FIGS. 3-5: A bar with slotted end, bolted to a sliding plate, is defined by these three figures. When all padlocks are closed, as in FIG. 3, the bar and slide can only be moved a limited distance toward any portion of the rotary assembly. When one padlock is opened with a key, as in FIG. 4, the bar and slide can be moved with one hand so as to pass either or both arms of the padlock shackle, thus making possible a subsequent action. FIG. 5 illustrates how an electrical push-button can be depressed by movement of the bar and slide, thereby connecting the low-voltage circuit of a typical battery-powered gate-opener. Also shown is an electrical cord for the integral lamp. Typically, both cords extend through support columns into the ground, thence to a low-voltage gate-opener and to the 120-volt wiring for an underground sensor, commonly installed with powered gate-openers for cars to exit.

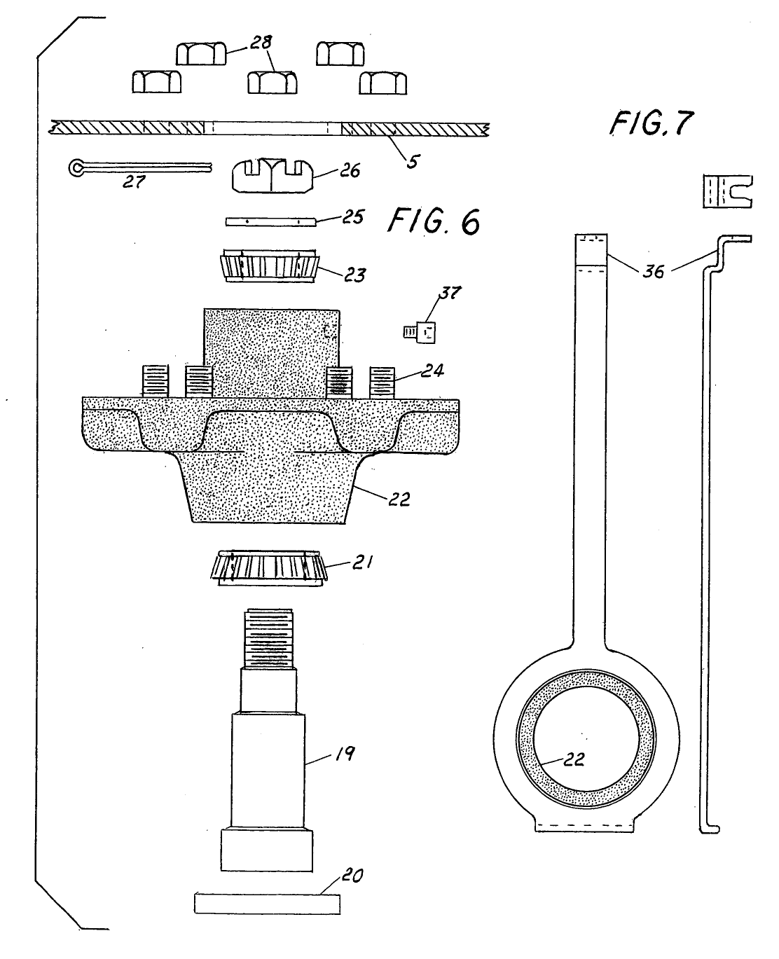

FIG. 6: An exploded view shows the construction of a typical automotive trailer hub, after minor changes so it can serve as a rotating hub that turns freely while minimizing vertical displacement of padlocks with respect to bar and slide described above. Other types of spindle/hub combinations that provide a firm support would be suitable.

FIG. 7: This is a simple pointer, one end of which fits the center of padlock rotation. The other end is formed so it will drop over the exposed edge of a padlock shackle. One purpose of the pointer is to facilitate rotating the assembly so an opened padlock will be opposite the slotted bar. Another purpose is to indicate a previous user of the rotary system, thereby helping to identify those not authorized to enter an enclosure.

FIG. 8: When a person is found to have violated stated rules about giving duplicate keys to others, or has gone elsewhere without returning a key, it may be determined that the lock corresponding to that person's key must be changed. If there were one lock and the same key for everyone, this would require transmitting a new key to all involved. By interchanging one padlock with another not yet in use, the rotary security system not only removes the need to change all keys but can help avoid damaged relations with the person at fault. FIG. 8 illustrates how specific padlocks can be removed easily from the lower rotating plate.

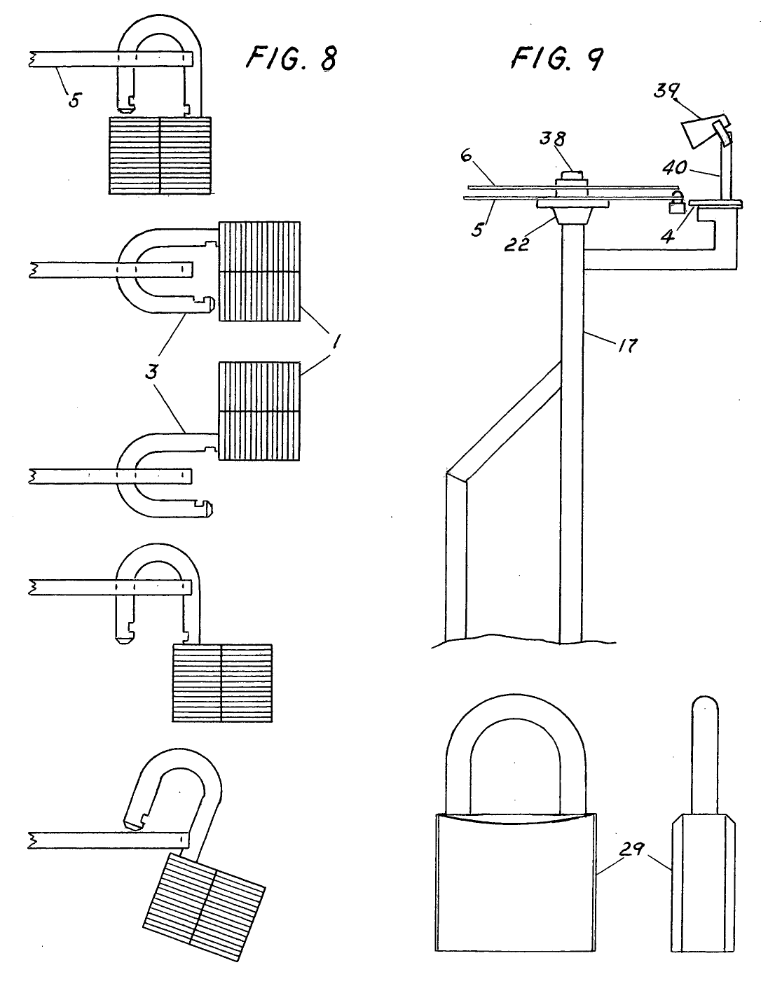

FIG. 9: Any desired number of padlocks can be utilized with the rotary system. In FIGS. 1 and 2, thirty-two padlocks of a wider type were shown. The resulting diameter of the rotating plate holding them was 12.4 inches. The lower illustration in FIG. 9 shows a commonly available brass padlock with narrower base. One hundred such padlocks can be arranged on a rotating plate with diameter of 21 inches. The top drawing of FIG. 9 shows the outline of a system of that size, mounted at car-window height.

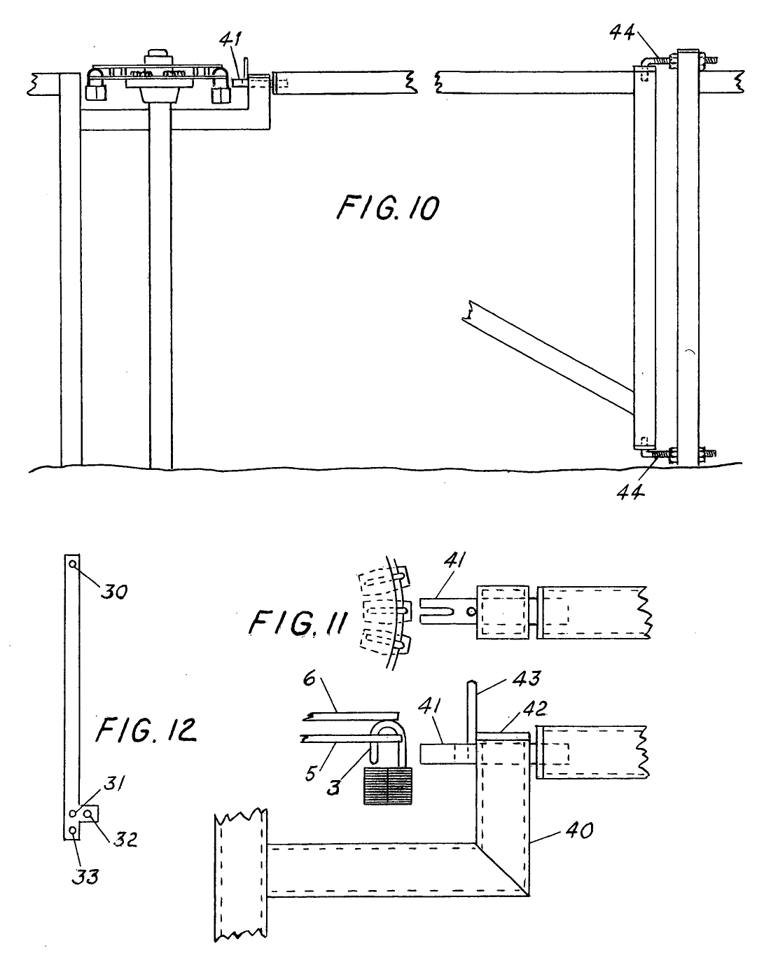

FIGS. 10, 11. When used as a manually operated gate opener, the rotary security system can be simplified while retaining its basic functional method. FIG. 10 shows how the same 32-padlock system of FIGS. 1 and 2 can be installed in this way. FIG. 11 illustrates a manually operated gate latch, inexpensive to construct. By using a narrower spindle and hub, the system will function properly with about seven padlocks installed. Since not all of these must be assigned to a user, there is no lower limit to the number of those authorized to enter a gated enclosure protected by this system.

FIG. 12. This sketch of a drill jig shows how the holes in a circular plate can be drilled easily and precisely.

### DETAILED DESCRIPTION

A keyed padlock is referred to herein as consisting of two components: the base, which includes a key insertion point plus internal lock mechanism, and the shackle, which consists of a hardened steel rod, formed near the center as a semicircle. The fact that some shackles are notched on only one end for grip within the base, and others are notched on both ends has no bearing on what is covered below.

All who have used a padlock know that its common purpose is to insert the open end of a shackle through one or more objects, such as a hasp or links of a chain, after which the padlock is closed, holding objects together or preventing separation. Unique features of the rotary security system evolve from the fact that the system makes use of a padlock function not ordinarily considered, rather than the usual function noted above. FIG. 1 illustrates that point. The closed padlock (base 1 and shackle 2) clearly has less distance between base and top of shackle than does the opened padlock (base 1 and shackle 3). The increased distance after opening varies somewhat according to padlock size and design. Commonly it is from ⅜ to 7/16 of an inch. This difference in length is sufficient to provide for functions unique to this invention, as descriptions that follow will indicate.

Bar 4, shown in FIGS. 2, 3, 4, 5, and 9, has a slot about 1/32-inch wider than shackle rod diameter, so that the bar can be moved to enclose the outer arm of shackles that are held securely by plates 5 and 6. Depending on the action intended after movement of bar 4, this slot can be long enough for the bar to extend so it also encloses, or even passes, the second arm of shackle 3. Both the vertical width and horizontal width of bar 4 must be such that the bar can move only a short distance unless a specific padlock has been opened and located in front of the bar. FIG. 3 shows that bar movement would be stopped by base 1 when the padlock is closed. FIG. 4 shows the bar extending past an arm of shackle 3 when the padlock is open. With reference to FIG. 1, horizontal width of bar 4 (not pictured in FIG. 1) must be narrow enough so it will pass easily between bases on either side of an opened padlock, such as bases 7 and 8 when the padlock between them is open. Horizontal width must be wide enough so it cannot be moved between any two adjacent padlocks that are closed. Vertical width of bar 4 must be such that the bar cannot pass between plate 5 and base 1 when the padlock is closed, but can easily pass between plate 5 and base 1 when the padlock has been opened. It is not possible to list specific vertical and horizontal width dimensions of bar 4, since padlocks vary in design, and their assembly within rotary security systems may also vary.

All padlocks for a rotary security system must be of the same design and size, although the cut of their keys will vary, as is known to be true. Since there are numerous key-cut combinations, adhering to one design and shape can be termed an advantage, since choice and purchase of a padlock would not be required of individuals who are authorized to use the rotary system.

Various actions can be incorporated into the system when bar 4 is moved as described above. One recommended action is illustrated by FIG. 5, which consists of a top view and two sectional views. Bar 4 is secured with cap-screws to slide 9, which is retained and guided by angular strips 10. Rectangular block 11, bolted to the base of slide 9, serves four functions: Block 11 prevents the slide from being removed. Block 11 provides a push-point for spring-arm 12, which acts to return the slide. Block 11 depresses push-button switch 13 after a predetermined movement distance of slide 9, thereby making possible the actuation of an electrically powered gate-opener or other electrical device. Low-voltage wiring 14 connects to the push-button. Block 11 contacts adjustable bolt 18, thus preventing damage to switch 13. After bar 4 is moved with one hand until contact between block 11 and bolt 18 occurs, the hand is free to close the opened padlock by squeezing it between thumb and fingers.

A description follows next of the rotating assembly pictured first in FIGS. 1 and 2. The spindle and hub of this assembly is shown in the exploded view of FIG. 6. This specific design involves only minor alterations of what is commonly sold by auto parts stores as a trailer hub. Said hub was selected for three reasons: low cost; turning on roller bearings, and wide support so as to secure plate 5 with minimal vertical displacement as the assembly shown by FIG. 2 is rotated. One end of spindle 19 is shortened from its purchased length, for welding to plate 20, which is later welded to support column 17. Tapered roller bearings 21 and 23, FIG. 6, fit on the spindle and within the machined center of hub 22. Five bolts supplied with trailer hub are removed and replaced with shorter bolts 24. The hub assembly is completed by attaching washer 25, nut 26, and cotter pin 27. Some lubrication of bearings is required, though less than on a road vehicle. As shown in the partial cross-sectional view of lower plate 5, FIG. 6, plate 5 is secured to the hub with nuts 28.

Plate 5, on which the selected padlocks are to be assembled, requires a dimensional layout for drilling two holes per padlock. Several variables must be considered in preparing for the layout. The number of padlocks required is determined from the maximum number required to accommodate personnel authorized to separately use the radial security system. If that number is between 20 and about 50, padlocks having a wider base are suitable, such as denoted by 1 in FIGS. 1 and 2. For a larger required number of padlocks, the selection of narrower brass padlocks will minimize plate diameter. These are depicted by 29, FIG. 9. For numbers less than 20, a smaller hub design is normally required. Such a hub can be as simple as a straight spindle within a close-fitting tube having a projecting flange two or three inches in diameter.

Padlocks should hang on plate 5 with only enough clearance between their bases to permit a base to drop from its shackle when a padlock is opened. For example, if the center of the base for padlock 29, FIG. 9, measures 9/16 of an inch in width, then the inner holes of plate 5 can properly be ⅝ of an inch apart, center to center. If 50 locks were required, simple calculations show the circular diameter between centers of inner holes of plate 5 to be 9.95 inches. Continuing the example, if shackle width, center to center is 1.15 inches, then the outer diameter of plate 5 would be 12.25 inches. Note that outer holes of plate 5 are half-circles only, but such holes would normally be drilled before plates are cut to size.

After such routine calculations, the layout and drilling of holes in plate 5 can be simplified by first making the simple drill jig shown by FIG. 12. To continue above example, assume that shackle rod diameter was found to be 0.255 inches, and trial on a short strip of steel, equal in thickness to that of plate 5, showed that 5/16-inch drilled holes would barely permit turning the shackle as in FIG. 8. Holes 31, 32, and 33 of FIG. 12 would then be carefully spaced and drilled to the 5/16-inch diameter. Hole 30 is needed only so the jig can be pivoted around a rod placed within a same-size hole at the center of plate 5. Hole for such a rod is drilled in plate 5 before cutting a larger opening to fit hub 22. To use the jig, holes 31, 32, and 33 are first used to drill through the plate, with jig clamped in place. Thereafter, the shank of a 5/16 drill can be inserted in hole 31 of jig and plate 5, after which a series of drilling holes 32 and 33 is continued. Such a procedure can be completed in little more time than that required to drill 100 holes randomly in quarter-inch steel plate, which is the recommended thickness for plates 5 and 6. A suggested step to avoid layout problems with this technique is to allow for one more set of padlock holes than initially determined—51 rather than 50 in above example. By doing so, if hole spacing with the drill jig does not end precisely, then plugging the last hole with a short bolt will not hinder later use of the system.

Remaining steps for completion of plate 5 consist of smoothly cutting the diameter to produce half-circles in outer holes, cutting out the center to fit hub 22, and drilling for the five bolt-holes. The center hole and bolt holes can be cut oversize, to assist in centering plate 5 when it is assembled. There should be no requirement for later removal of plate 5 to add or remove padlocks.

The diameter of plate 6 is such that the plate will extend slightly past the top center of all shackles. Plates 5 and 6 can be clamped together for drilling holes to be threaded in plate 5 for cap-screws 34, after which a tap is run through the holes of plate 6, and the holes in plate 5 are enlarged. If desired for security reasons, cap-screws can be inserted through plate 5, with holes threaded in plate 6. Sleeves 35, through which cap-screws 34 are placed, need not fit the screws closely. The length of sleeves 35 should be slightly less than the height of padlock shackle tops above plate 5. This will permit tightening cap-screws 34 to secure the shackles firmily. Pointer 36, shown in FIG. 7, has few dimensional requirements. The slot at its end should fit loosely over the top of shackles, without binding on plate 5. The width of pointer 36 at its end should be the same as that determined for horizontal width of bar 4. Pointer 36 must be easy to grasp, easy to turn, and not obstructed by cap-screws 34. One or more of cap-screw 37, shown by FIG. 6, can be inserted into threaded holes at the top of hub 22, thereby thwarting later removal of pointer. Insertion of grease-cap 38 completes assembly of the rotating unit.

Lamp 39 should be one selected for outdoor use, small, and not easily broken. Lamp-arm 40 can be of a shape best suited for attachment of the lamp. Lamp-arm 40 is secured to support-arm 16 either by cap-screws as shown in FIG. 5, or by welding. Wiring passes through support-arm 16, support-column 17, and normally into the ground. Such wires from the lamp can be routed to the nearest connection point, which may be the wiring to an underground sensor that opens the gate when a car exits the enclosed area.

FIG. 10 illustrates how the rotary security system can be adapted for manually locking and unlocking the entrance to an enclosure. No reference numbers are shown on the rotary system in the drawing of FIG. 10 because its size, as pictured by the drawing, is similar to that shown by FIG. 2. Gate and fence structures in this drawing are intended to be symbolic only. Support-column 40 differs from support-column 16 of FIG. 2, requiring only vertical cuts at the top. Cap 42 is welded to support-column 40. Sliding bar 41 is configured the same as bar 4 on the end facing the rotary assembly, although the slot of bar 41 may require a longer length unless the gate or door is known to remain closely fitted against support-column 40. Horizontal and vertical width dimensions for both ends of sliding bar 41 are configured the same. Rod 43 not only assists in gate entry or exit, but it also prevents removal of sliding bar 41. Thus, rod 43 is peened after insertion in sliding bar 41, or otherwise secured to prevent removal at the usage site. Adjustable pivot supports 44 are commonly available and may be required for gate adjustment to assure smooth latching action.

Recommendations are next listed concerning material requirements for specific parts. These recommendations are intended to be flexible, depending on where the rotary security system will be installed. In general, padlocks are known to be weather resistant, suitable for outdoor use. A simple cover for the rotating assembly can be made for use where climatic conditions are severe. As noted above, plates 5 and 6 can properly be ¼″ thick, with stainless steel preferable for appearance. Plate 6 can be of aluminum. Plate 5 can also be of aluminum if an experiment is made to determine the required thickness for rigidity and to permit insertion of shackle arms as in FIG. 8. All of the supporting columns and structures shown in FIGS. 1-11 can properly be made from 2×2-inch square steel tubing, welded where appropriate and painted to resist corrosion. Wall thickness of the square tubing should be selected to assure columnar support. The wall thickness of column 16 should be adequate for tapped holes shown by FIG. 5. Bar 4 can be of stainless steel, hardened tool steel, or brass, with material selection such that deformation of the slotted end is not likely to occur. Consider brass for slide 9 and angular strips 10, to resist corrosion.

Operation of the rotary security system becomes routine and easy after a person not familiar with it is shown the simple steps required. To avoid possible questions by someone who has not used the system previously, it is recommended that brief instructions be made weatherproof and then affixed to support column 16, where they can easily be seen. Wording can be somewhat like that shown below.

### How to Use Rotary Security System

### Location of Pointer Identifies Previous Entrant.

1. Move pointer to your lock number.

2. Insert key in base of lock and open it.

3. Rotate so pointer is opposite slotted bar.

4. Shove bar past arm of lock until it stops.

5. Release bar and close lock with fingers.

6. Without delay, drive through opened gate.

What I claim in my invention is as follows:

1. A rotary security system, comprising
(a) a plurality of padlocks of about uniform size, fixed in position such that when all said padlocks are locked, the straight portions of shackle rods of said padlocks are approximately parallel, and the tops of bases of said padlocks are approximately in the same horizontal plane,
(b) a slidable bar disposed to move parallel to said horizontal plane, with one end of said slidable bar disposed to move toward a selected padlock,
(c) a slot in said end of said slidable bar, the sides of said slot being about parallel to straight vertical portions of said padlocks, said slot being wider than diameter of said shackle rods, and length of said slot being determined by intended use of said security system,
(d) means of moving said slidable bar a predetermined distance parallel to said horizontal plane after, and only after, unlocking said selected padlock and positioning the shackle rods and base thereof opposite said slot in said end of said slidable bar.

2. The rotary security system of claim 1, wherein said means comprises a rigid and rotatable circular plate, parallel to said horizontal plane, with holes in said circular plate to accommodate said shackle rods of said padlocks, and a circular surmounting plate, or other means, disposed so as to press against the bent portion of said shackle rods, thereby preventing unrestricted removal of any of said padlocks and also positioning said bases of said padlocks such that any one of said padlocks can be placed opposite said slot of said end of said slidable bar.

3. The rotary security system of claim 2, wherein said holes for each connected pair of said shackle rods are on a radial line extending from the center of said rotatable circular plate.

4. The rotary security system of claim 3, wherein said holes for the fixed arm of said shackle rods are on an outer circumference line of said circular plate, with holes for the free-swinging arm of said shackle rods being on an inner circumference line of said circular plate, and the circumferential distance between adjoining sets of said holes for each pair of said shackle rods being no greater than required for free movement of padlock bases extending from said shackle rods, thereby making possible the opening or closing of padlock bases extending from said shackle rods.

5. The rotary security system of claim 4, wherein all of said holes for said shackle rods are of such diameters as to provide about minimum clearance for said shackle rods, thereby retaining said shackle rods in approximate vertical position.

6. The rotary security system of claim 4, wherein all outer holes for said shackle rods are cut or otherwise formed approximately in half, so that only the inner semicircles remain, thereby providing a means for subsequent insertion and removal of said shackle rods from said holes of said circular plate.

7. The rotary security system of claim 2, wherein the center of said rotatable circular plate is mounted on, or otherwise affixed to, a hub which rotates freely, has minimum deflection, and is securely attached to a rigid frame of desired height and orientation, thereby making said security system such that it can be used easily by the driver of a vehicle.

8. The rotary security system of claim 2, wherein said surmounting plate or said other means are imprinted with numbers or letters which designate the location of specific padlocks.

9. The rotary security system of claim 2, wherein said surmounting plate or said other means is equipped with a pointer which can be pivoted or otherwise moved to indicate a specific one of said padlocks, thereby serving as a guide for subsequent location of said specific one of said padlocks opposite said slot of said slidable bar.

10. The rotary security system of claim 2, wherein said slidable bar is disposed such that the top of said slot in said end of said slidable bar is below the bottom side of said rotatable circular plate, thereby providing a way for said slidable bar to move longitudinally toward said bases of said padlocks and their corresponding shackle rods.

11. The rotary security system of claim 2, wherein said slidable bar, when not in use, is disposed an approximate minimum distance from said bases of said padlocks, thereby assuring free rotation of said circular plate when searching for a specific one of said padlocks.

12. The rotary security system of claim 2, wherein vertical width of said slidable bar is less than the distance between bottom of said circular plate and top of the opened base of any one of said padlocks, and greater than the distance between bottom of said circular plate and top of the closed base of any one of said padlocks.

13. The rotary security system of claim 2, wherein horizontal width of said slidable bar is such that linear movement of said slidable bar toward said padlocks cannot occur beyond any portion of said bases of said padlocks when all of said padlocks are closed, but such linear movement is not restricted by said bases of said padlocks, or by said shackle rods, when any one of said padlocks has been opened and disposed opposite said slot of said slidable bar.

14. The rotary security system of claim 13, wherein a predetermined distance of longitudinal movement of said slidable bar will enable said slot in the end of said slidable bar to extend past one or both of said shackle rods, thereby actuating an electrical switch or other electrical device.

15. The rotary security system of claim 14, wherein said longitudinal movement of said slidable bar is blocked at a point such that damage cannot occur to said electrical switch or to said other electrical device.

16. The rotary security system of claim 14, wherein said slidable bar is disposed such that said slidable bar can be moved easily by hand, with returning movement actuated by a spring or other device, thereby eliminating the need to withdraw said slidable bar by hand.

17. The rotary security system of claim 1, wherein said slidable bar is disposed within a supporting frame such that said slidable bar can neither be moved longitudinally in either direction beyond its intended path, nor removed entirely from said supporting frame, without the use of special tools or equipment, thereby hindering malicious disassembly of said system.

18. The rotary security system of claim 1, wherein the non-slotted end of said slidable bar is further lengthened, extending far enough beyond the supporting frame such that it serves as a manually operated latch for a gate, or for other forms of closure which involve movement of a bar.

19. The rotary security system of claim 18, wherein said slidable bar is further disposed such that the non-slotted end of said slidable bar extends through a close-fitting opening within said supporting frame, thereby simplifying the way in which said slidable bar might otherwise be disposed within said supporting frame.

20. The rotary security system of claim 19, wherein said slidable bar is further modified with a handle for manual operation, and with said handle disposed such that said slidable bar cannot be removed without special tools or equipment, thereby providing increased security.
